(19) United States
(12) Patent Application Publication
(10) Pub. No.: US 2017/0111090 A1
(43) Pub. Date: Apr. 20, 2017

(54) TERMINAL AND BASE STATION IN DISTRIBUTED ANTENNA SYSTEM AND OPERATION METHOD THEREOF

(71) Applicant: ELECTRONICS AND TELECOMMUNICATIONS RESEARCH INSTITUTE, Daejeon (KR)

(72) Inventors: Junyoung NAM, Daejeon (KR); Young Jo KO, Daejeon (KR)

(73) Assignee: ELECTRONICS AND TELECOMMUNICATIONS RESEARCH INSTITUTE, Daejeon (KR)

(21) Appl. No.: 15/128,695

(22) PCT Filed: Mar. 24, 2015
(86) PCT No.: PCT/KR2015/002882

§ 371 Date: Sep. 23, 2016

(30) Foreign Application Priority Data
Mar. 25, 2014 (KR) 10-2014-0034879
Oct. 21, 2014 (KR) 10-2014-0142858
Nov. 7, 2014 (KR) 10-2014-0154769
Mar. 24, 2015 (KR) 10-2015-0040572

(51) Int. Cl. H04B 7/04; H04B 7/02; H04B 17/24; H04L 5/00; H04B 17/336

(52) U.S. Cl. CPC H04B 7/0417; H04L 5/0048; H04B 17/336; H04B 17/24; H04B 7/024; H04W 84/045

(57) ABSTRACT

Disclosed herein are a terminal and a base station in a distributed antenna system and an operation method thereof. A base station may include first and second transmitter points positioned at different places. The base station transmits a reference signal for channel quality measurement to the terminal. The terminal calculates a first value that is a ratio of a signal transmitted to the terminal and noise based on the received reference signal. Further, the terminal calculates a second value that is a ratio of interference by a first transmitter point and noise and a third value that is a ratio of interference by a second transmitter point and noise, based on the received reference signal. The terminal transmits information on the first to third values to the base station.

### TECHNICAL FIELD

The present invention relates to a terminal and a base station in a distributed antenna system and an operation method thereof.

### BACKGROUND ART

Since 4G, mobile communication systems require a 1000 times higher frequency efficiency, a 1000 times higher energy efficiency, and a 1000 times higher acceptance increase of device due to a rapid increase in data traffic, compared to those of a 4G system such as 3GPP LTE. As physical layer technologies for increasing the frequency efficiency, there are a network MIMO, an interference alignment, a relay network, a heterogeneous network, a large-scale antenna, a distributed antenna system, etc.

The distributed antenna system is a technology of separating a function of a base station into a radio unit (RU) and a digital unit (DU) and dividing the RU (i.e., antenna part or transmitter point) into plural to distribute the RU. In the distributed antenna system, there is a need to obtain channel quality indication to allow the digital unit to perform multi-input multi-output (MIMO) transmission through a plurality of radio units. To obtain the channel quality indication, many reference signals and radio resources for channel quality indication feedback are required.

Further, in the distributed antenna system, there is a problem in that scheduling and precoding computation complexity is increased due to the increase in the number of users who may be simultaneously accepted

### DISCLOSURE

### Technical Problem

The present invention has been made in an effort to provide a terminal and a base station in a distributed antenna system and an operation method thereof having advantages of reducing feedback for channel quality indication in the distributed antenna system.

### Technical Solution

An exemplary embodiment of the present invention provides an operation method of a terminal communicating with a base station including first and second transmitter points positioned at different places. The operation method of a terminal includes: receiving a reference signal for channel quality measurement from the base station; calculating a first value that is a ratio of a signal transmitted to the terminal and noise based on the reference signal; calculating a second value that is a ratio of interference from the first transmitter point and noise based on the reference signal; calculating a third value that is a ratio of interference from the second transmitter point and noise based on the reference signal; and feed backing information on the first to third values to the base station.

The base station may calculate channel quality indication for multiple transmitter MIMO based on the first to third values.

The base station may perform scheduling for the multiple transmitter MIMO based on the calculated channel quality indication.

The multiple transmitter MIMO may be a scheme of transmitting data as the same resources to the terminal and other terminals other than the terminal through the first and second transmitter points.

The operation method may further include: when a value obtained by dividing the second value by the first value is equal to or larger than a predetermined threshold value, allocating the second value as a fourth value; and when a value obtained by dividing the third value by the first value is smaller than the predetermined threshold value, allocating the third value as a fifth value, in which information on the second value corresponds to the fourth value and information on the third value may correspond to the fifth value.

The fourth value and the fifth value may be 1 bit information.

The base station may be a small base station and the small base station may be wirelessly connected to a macro base station and may be connected to a back haul wirelessly and through the macro base station.

The first transmitter point and the second transmitter point may be positioned in different buildings.

Another embodiment of the present invention provides an operation method of a base station including first and second radio units distributed from each other and a digital unit connected to first and second radio units

An operation method of a base station includes: transmitting a reference signal for channel quality measurement to a terminal; receiving a first value that is a ratio of a signal transmitted to the terminal and noise calculated based on the reference signal from the terminal; receiving a second value that is a ratio of interference by the first radio unit and noise calculated based on the reference signal from the terminal; and receiving a third value that is a ratio of interference by the second radio unit and noise calculated based on the reference signal from the terminal.

The operation method may further include: calculating channel quality indication for multiple transmitter MIMO based on the first to third values.

The operation method may further include: performing scheduling for the multiple transmitter MIMO based on the calculated channel quality indication.

The multiple transmitter MIMO may be a scheme of transmitting, by the base station, data as the same resources to the terminal and other terminals other than the terminal through the first and second radio units.

The base station may be a small base station and the small base station may be wirelessly connected to a macro base station and may be connected to a back haul wirelessly and through the macro base station.

Yet another embodiment of the present invention provides a terminal communicating with a base station including first and second transmitter points distributed at different places. The terminal includes: an RF module receiving a reference signal for channel quality measurement from the base station; and a processor calculating a first value that is a ratio of interference by the first transmitter point and noise and a second value that is a ratio of interference by the second transmitter point and noise based on the reference signal.

The processor may calculate a third value that is a ratio of a signal transmitted to the terminal and noise based on the reference signal.

The RF module may feedback information on the first to third values to the base station.

The processor may allocate the first value as a fourth value when a value obtained by dividing the first value by the third value is equal to or larger than a predetermined threshold value; and may allocate the second value as a fifth value when a value obtained by dividing the second value by the third value is equal to or larger than the predetermined threshold value.

The RF module may feedback the third value, the fourth value, and the fifth value to the base station.

The fourth value and the fifth value may be 1 bit information.

### Advantageous Effects

According to an exemplary embodiment of the present invention, the terminal may not measure and report the channel quality indication from all of the transmitter points but feeds back only the predetermined interference signal intensity to reduce the feedback overhead.

### DESCRIPTION OF THE DRAWINGS

FIG. 1 is a diagram illustrating a wireless communication system according to an exemplary embodiment of the present invention.

FIG. 2 is a diagram illustrating a small base station according to an exemplary embodiment of the present invention.

FIG. 3 is a diagram illustrating an environment that a plurality of radio units of FIG. 2 are crowded.

FIG. 4 is a diagram illustrating interference and a signal in a MT-MIMO environment according to an exemplary embodiment of the present invention.

FIG. 5 is a diagram illustrating an operation method of a terminal and a small base station in a distributed antenna system according to the exemplary embodiment of the present invention.

FIG. 6 is a diagram illustrating a terminal according to an exemplary embodiment of the present invention.

### MODE FOR INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, a terminal may be called a mobile terminal (MT), a mobile station (MS), an advanced mobile station (AMS), a high reliability mobile station (HR-MS), a subscriber station (SS), a portable subscriber station (PSS), an access terminal (AT), user equipment (UE), and the like and may include functions of all or some of the terminal, the MT, the AMS, the HR-MS, the SS, the PSS, the AT, the UE, and the like

Further, a base station (BS) may be called an advanced base station (ABS), a high reliability base station (HR-BS), a nodeB, an evolved node B (eNodeB), an access point (AP), a radio access station (RAS), a base transceiver station (BTS), a mobile multihop relay (MMR)-BS, a relay station (RS) serving as a base station, a high reliability relay station (HR-RS) serving as a base station, and the like and may also include functions of all or some of the ABS, the HR-BS, the nodeB, the eNodeB, the AP, the RAS, the BTS, the MMR-BS, the RS, the HR-RS, and the like.

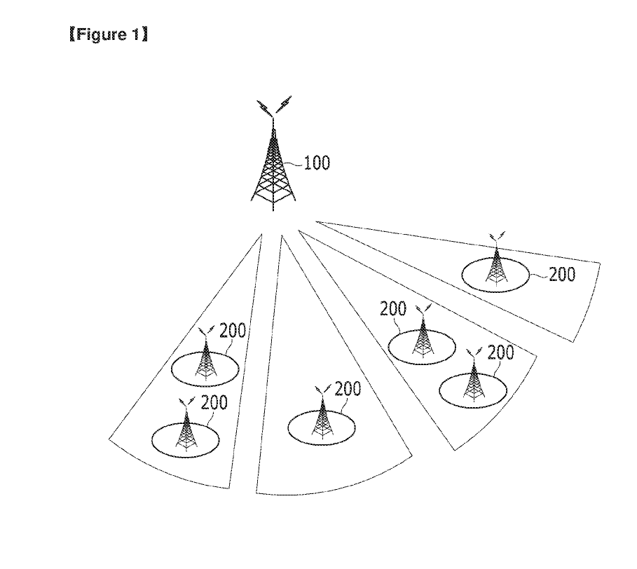

FIG. 1 is a diagram illustrating a wireless communication system according to an exemplary embodiment of the present invention.

As illustrated in FIG. 1, a wireless communication system according to an exemplary embodiment of the present invention includes a macro base station 100 and a plurality of small base stations 200.

The macro base station 100 is connected a back haul (core network) through a wire and is wirelessly connected to the plurality of small base stations 200. The macro base station 100 provides a wireless back haul link to the plurality of small base stations 200 and the plurality of small base stations 200 each are wirelessly connected to the back haul through the macro base station 100. Meanwhile, the macro base station 100 according to the exemplary embodiment of the present invention may include a high-scale antenna.

A channel between the macro base station 100 installed in high building and the small base station 200 installed at a low place has transmit antenna correlation. The transmit antenna correlation may be represented by an angle of departure (AoD) and angular spread (AS). The macro base station 100 may reduce an energy loss and transmit data, when being beamformed to the small base station 200 based on the transmit antenna correlation. This is called a tunnel effect and to implement the tunnel effect, the small base station 200 needs to be implemented as a distributed antenna system (i.e., distributed receiving antenna array).

Meanwhile, to increase transmission efficiency of a wireless back haul using the distributed antenna system of the small base station 200, there is a need to install the distributed antenna at an optimal position by channel measurement. The channel between the macro base station 100 and the small base station 100 is a very slow fading channel and a transmit correlation matrix is little changed. Therefore, the beamforming optimized by a fixed transmit correlation matrix may be performed and implementation complexity and costs of the large-scale antenna system may be reduced by a mixing of fixed beamforming (analog beamforming) with digital beamforming. The analog beamforming may be semi-statically changed depending on a distribution of terminals in the daytime and at night.

According to the exemplary embodiment of the present invention, the small base station 200 is wirelessly connected to the back haul network (core network) through the macro base station 100 and therefore costs due to a construction of a dedicated wired network may be saved.

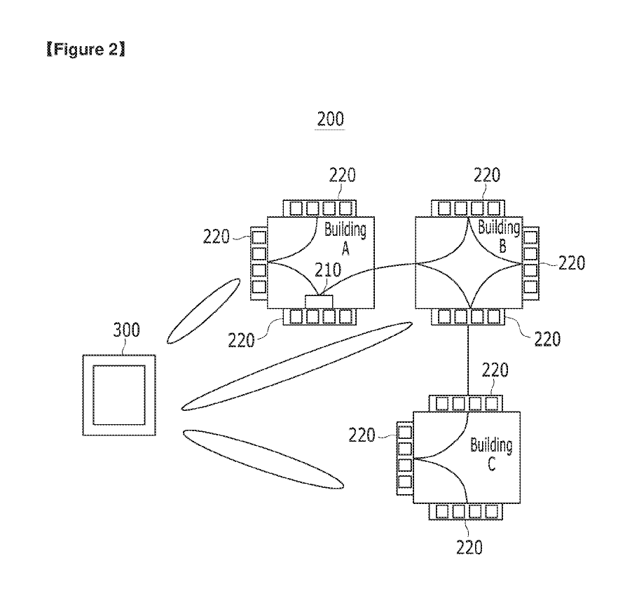

As described above, the small base station 200 according to the exemplary embodiment of the present invention has the distributed antenna system (distributed antenna array), which will be described in detail with reference to FIG. 2.

FIG. 2 is a diagram illustrating the small base station 200 according to the exemplary embodiment of the present invention.

As illustrated in FIG. 2, the small base station 200 according to the exemplary embodiment of the present invention includes a digital unit (DU) 210 and a plurality of radio units (RUs) 220.

The plurality of radio units 220 are separated from each other and may thus be disposed in different buildings. As illustrated in FIG. 2, three radio units may be disposed in building A, three radio units may be disposed in building B, and three radio units may be disposed in building C. Meanwhile, a plurality of radio units 220 are connected to each other through a dedicated network. Meanwhile, the plurality of radio units 220 each may include a plurality of antennas.

The digital unit (DU) 210 corresponds to the rest parts other than an antenna part from a base station function of the small base station 200. The digital unit (DU) 210 according to the exemplary embodiment of the present invention may select an optimal radio unit depending on an access link channel state to the terminal 300 among the plurality of radio units 200. That is, the digital unit (DU) 210 may turn on or off an operation of a specific antenna array (radio unit) depending on the distribution of the terminals 300 or the channel state. A cooperation MIMO transmission may be made through the optimal transmitter point (i.e., radio unit) using the reconfigurable distributed antenna and the terminal 300 may perform transmission/reception at a high data rate. The cooperation MIMO transmission is similar to a multi user-MIMO (MU-MIMO) in which the transmitter points are plural and the terminals are plural, but the transmitter points are positioned at different places and therefore it may be called a multi transmitter MIMO (MT-MIMO). That is, in the MT-MIMO, the plurality of radio units positioned at different places uses the same resource to transmit data to the plurality of terminals (i.e., multi-user). Meanwhile, the digital unit (DU) 210 transmits control information through downlink control information (DCI) so that each terminal may recognize the transmitter points allocated to each terminal.

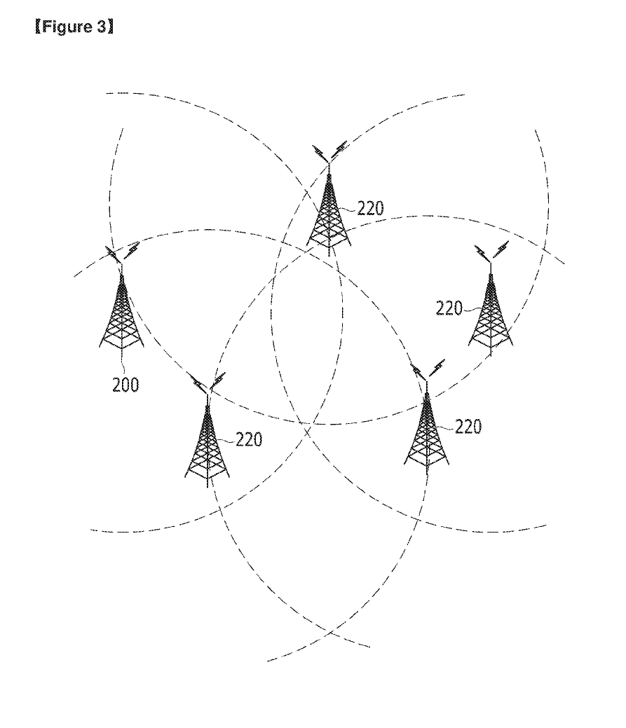

FIG. 3 is a diagram illustrating an environment that the plurality of radio units 220 of FIG. 2 are crowded.

As illustrated in FIG. 3, the plurality of radio units 220 are each positioned at different places and areas serviced by the plurality of radio units 220 overlap with each other. That is, cells serviced by each of the radio units 220 overlap with each other and are crowded. Unlike the typical cooperation transmission in which the cells do not overlap with each other, in the environment of FIG. 3, the cells overlap with each other while being crowded. In the environment that the cells overlap with each other and crowded, the signals transmitted by the plurality of radio units 220 act as mutual interference. Hereinafter, a method for feeding back channel quality indication under the crowded distributed antenna system environment as illustrated in FIG. 3 will be described.

Meanwhile, in the following description, terms of the radio unit 220 and the transmitter point (TX point) are used together. In FIGS. 2 and 3, the transmitter point corresponds to one radio unit (RU) 220 and the plurality of transmitter points may each include the plurality of antennas.

Typically, the terminal directly measures and reports channel quality indication (CQI) for the MU-MIMO. That is, typically, the terminal directly calculates the CQI for the MU-MIMO and feeds back the calculated CQI to the small base station but the terminal according to the exemplary embodiment of the present invention does not directly calculate the CQI for the MU-MIMO. According to the exemplary embodiment of the present invention, for the small base station 100 to estimate the CQI for the MT-MIMO, the terminal feeds back only predetermined information (for example, MTI to be described below). When the transmitter point is plural, the terminal needs to know all of the transmit power of the transmitter points to calculate the CQI for the MT-MIMO. However, the positions of the transmitter points are totally different and therefore the terminal may not measure the CQI. Further, the number of cases in which the terminal calculates the CQI for the MT-MIMO is too many, and as a result a burden on the feedback may be increased. Therefore, according to the exemplary embodiment of the present invention, the terminal feeds back only the predetermined information (for example, MTI) to be described below. Meanwhile, a non-zero power channel state information-reference signal (CSI-RS) and a zero power CSI-RS are appropriately allocated between multi-transmitter points.

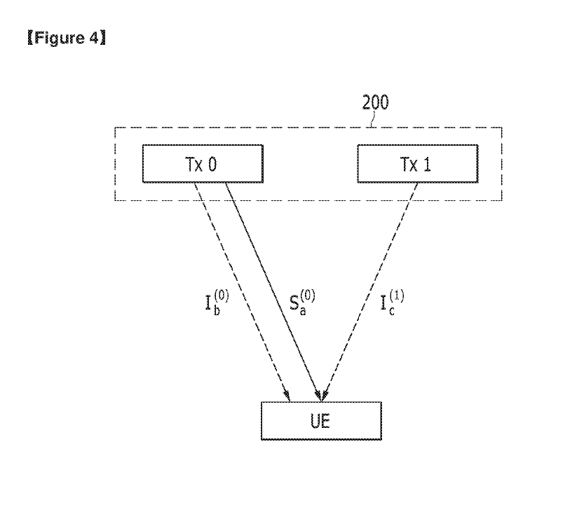

Hereinafter, a method for calculating CQI for MT-MIMO according to the exemplary embodiment of the present invention will be described with reference to FIG. 4.

FIG. 4 is a diagram illustrating interference and a signal in a MT-MIMO environment according to an exemplary embodiment of the present invention.

In FIG. 4, a transmitter point Tx0 and a transmitter point Tx1 are each positioned at different places and each correspond to the RUs 200 of FIG. 2. It is assumed that the transmitter point TxO transmits data to the terminal (UE) and transmits data even to other terminals (not illustrated) other than the terminal (UE) using the same resource. Further, it is assumed that the transmitter point Tx1 transmits data to other terminals other than the terminal (UE) using the same resource. For convenience, it is assumed that in FIG. 4, the transmitter point is two, but the exemplary embodiment of the present invention described below may be applied to the case in which the transmitter point is three or more.

In FIG. 4, a signal transmitted to other terminals by the transmitter point Tx0 acts as interference in terms of the terminal (UE), and therefore the interference is represented by I_{b}⁽⁰⁾. Further, a signal transmitted to other terminals by the transmitter point Tx1 acts as interference in terms of the terminal (UE), and therefore the interference is represented by I_{c}⁽¹⁾. Further, a signal transmitted to the terminal (UE) by the transmitter point Tx0 is represented by DeletedTexts.

For convenience, the CQI for the MT-MIMO is called ‘MT-CQI’. Here, the MT-CQI corresponds to a signal interference noise ratio (SINR) of the terminal (UE), and therefore the MT-CQI estimated by the small base station 200 is defined as the following Equation 1.

$$M T \text{-} C Q I = S I N R = \frac{{S}_{a}^{( 0 )}}{2 N + {I}_{b}^{( 0 )} + 2 {I}_{c}^{( 1 )} ( or {I}_{c}^{( 1 )} + {I}_{d}^{( 1 )} ) } \qquad ( Equation 1 )$$

In the above Equation 1, N represents interference signal intensity due to background noise and other cells, constant 2 represents power of the small base station 200 transmitted in two data streams while being divided by ½ and may be changed depending on the number of transmitter points. The superscript represents an index of the transmitter point and the subscript represents a precoding matrix index (PMI).

As illustrated in the above Equation 1, a denominator represents the noise and the interference signal intensity which are undergone by the terminal (UE) and a numerator represents the signal intensity received by the terminal (UE). In the above Equation 1, when the denominator and the numerator are divided by N, the following Equation 2 is obtained.

$$M T \text{-} C Q I = \frac{\frac{{S}_{a}^{( 0 )}}{N}}{2 + ( {I}_{b}^{( 0 )} / N ) + 2 ( {I}_{c}^{( 1 )} / N ) } = \frac{S N {R}_{a}^{( 0 )}}{2 + I N {R}_{b}^{( 0 )} + 2 I N {R}_{c}^{( 1 )} } \qquad ( Equation 2 )$$

In the above Equation 2, INR represents an interference-to-noise ratio, which may be replaced by a multi transmitter interference signal indicator (MUI) defined below. Further, SNRₐ⁽⁰⁾ represents a ratio of magnetic signal Sₐ⁽⁰⁾ of the terminal (UE) and noise, which corresponds to the CQI used in a typical LTE system. Therefore, finally, the MT-CQI may finally be represented by the following Equation 3.

$$M T \text{-} C Q I = \frac{C Q {I}_{a}^{( 0 )}}{2 + M T {I}_{b}^{( 0 )} + 2 M T {I}_{c}^{( 1 )} } \qquad ( Equation 3 )$$

Considering the above Equations 2 and 3, the MTI for efficient feedback may be defined as the following Equation 4.

MTI_{b}⁽⁰⁾=I_{b}⁽⁰⁾/N

MTI_{c}⁽¹⁾=I_{c}⁽¹⁾/N (Equation 4)

The terminal UE according to the exemplary embodiment of the present invention calculates only information on the CQIₐ⁽⁰⁾ and the MTI used in the typical LTE system and transmits the calculated information. In other words, the terminal (UE) calculates Sₐ⁰/N that is a ratio of the signal Sₐ⁰ transmitted to the terminal and noise and feeds back the calculated Sₐ⁰/N to the small base station 200. Further, the terminal (UE) calculates I_{b}⁽⁰⁾/N that is a ratio of interference from the transmitter point Tx0 and noise and I_{c}⁽¹⁾/N that is a ratio of interference from the transmitting Tx1 and noise, respectively, and feeds back the calculated I_{b}⁽⁰⁾/N and I_{c}⁽¹⁾/N to the small base station 200. According to the exemplary embodiment of the present invention as described above, it is possible to reduce feedback overhead of the terminal.

The small base station 200 uses the CQIₐ⁽⁰⁾, MTI_{b}⁽⁰⁾, and MTI_{b}⁽¹⁾ fed back from the terminal (UE) to finally calculate the MT-CQI depending on the above Equation 3. Here, the MT-CQ1 is calculated by the digital unit 210 of the small base station 200. The digital unit 210 may use the information CQIₐ⁽⁰⁾, MTI_{b}⁽⁰⁾, and MTI_{b}⁽¹⁾ fed back from the terminal (UE) to calculate the MT-CQI, thereby estimating the interference degree between the multi transmitter points. As a result, the digital unit 210 may perform scheduling and link adaptation for the multi-user.

When the terminal (UE) feeds back only the MTI information independent of transmit power of other transmitter points (for example, transmitter point Tx1), the small base station 200 (i.e., digital unit (DU) 210) knows the transmit power per a data stream of all the transmitter points and therefore may easily calculate the MT-CQI. That is, the small base station 200 knows the transmit power for each transmitter point and therefore may flexibly perform the scheduling.

For example, it is assumed that the transmitter point Tx1 uses c, d, and e that are three PMIs to perform the transmission with equal power of ⅓

In this case, when the terminal (UE) feeds back CQIₐ⁽⁰⁾ MTI_{b}⁽⁰⁾, MTI_{b}⁽¹⁾, MTI_{d}⁽¹⁾, and MTIₑ⁽¹⁾, the small base station 200 may know the transmit power per the data stream of the transmitter point Tx1 and therefore may calculate the MT-CQI as the following Equation 5.

$$M T \text{-} C Q I = \frac{C Q {I}_{a}^{( 0 )}}{2 + M T {I}_{b}^{( 0 )} + \frac{2}{3} M T {I}_{c}^{( 1 )} + \frac{2}{3} M T {I}_{d}^{( 1 )} + \frac{2}{3} M T {I}_{e}^{( 1 )}} \qquad ( Equation 5 )$$

Conventionally, the terminal may not know other transmitter points other than the transmitter point (i.e., transmitter point of terminal) of the terminal and therefore the terminal is hard to calculate the MT-CQI. Therefore, the terminal may not receive several data streams from the multi transmitter points. However, according to the exemplary embodiment of the present invention described above, the terminal simply feeds back only the CQI and the MTI and the base station may know the transmit power of each transmitter point and may easily calculate the MT-CQI.

Meanwhile, the MTI information fed back to the small base station 200 by the terminal UE may reduce the MIT overhead by the following method. The terminal UE may simplify the MUI into 1 bit information based on a ratio of the MTI and the SNRₐ⁽⁰⁾ depending on the following Equation 6, having a specific threshold value x.

$$\begin{matrix}If \frac{M T I}{S N {R}_{a}^{( 0 )}} Dx , & M T I {0}^{′} {1}^{′} \\ If \frac{M T I}{S N {R}_{a}^{( 0 )}} > x , & M T I {0}^{′} {0}^{′}\end{matrix} \qquad ( Equation 6 )$$

As represented in the above Equation 6, if the ratio of the MTI and SNRₐ⁽⁰⁾ is equal to or smaller than the threshold value x, the terminal UE allocates ‘1’ as the MTI information. Further, when the ratio of the MTI and SNRₐ⁽⁰⁾ is larger than the threshold value x, the terminal UE allocates ‘0’ as the MTI information. That is, the terminal UE does not feedback the detailed interference level but divides and feeds back an interference beam having a very small interference level and an interference beam which does not have a very small interference level. As such, the MTI feedback information is reduced to one bit information, and therefore the MTI feedback overhead may be reduced.

Meanwhile, since the MUI is highly likely to be 1 in a channel in which spatial correlation (or angular spread) is large and the number of ‘Os’ is very small in the whole bit, in the case of using a compressive sensing technology, the one bit information may more reduce the feedback overhead.

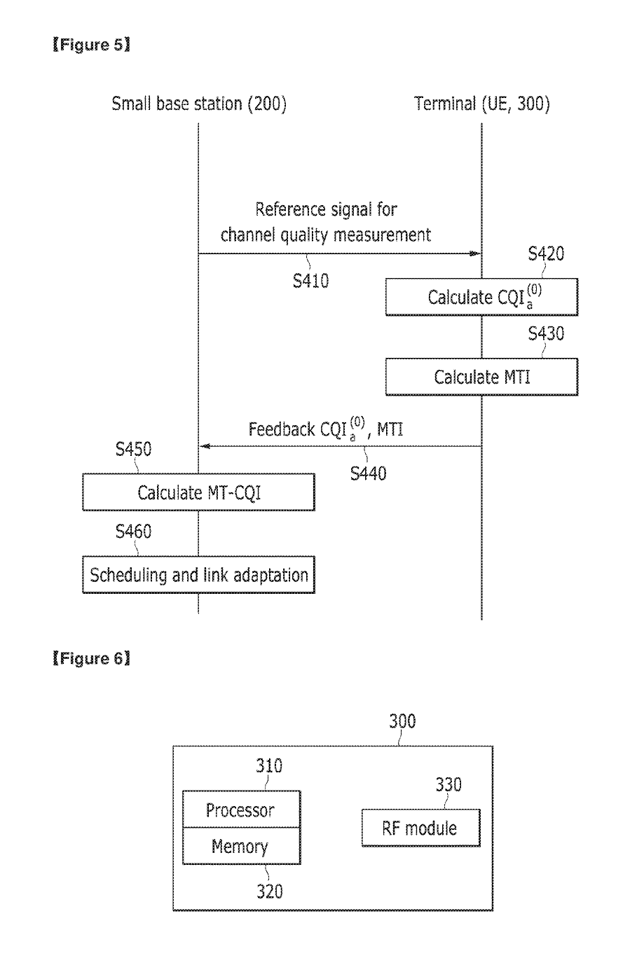

FIG. 5 is a diagram illustrating an operation method of a terminal and a small base station in a distributed antenna system according to the exemplary embodiment of the present invention.

First, the small base station 200 transmits the reference signal for the channel quality measurement to the terminal (UE) 300 (S410). Here, the reference signal for the channel quality measurement may be the channel state information—reference signal (CSI-RS). The CSI-RS may be appreciated by a person having ordinary skill in the art to which the present invention pertains and the detailed description thereof will be omitted. The small base station 200 according to the exemplary embodiment of the present invention has the plurality of transmitter points distributed as illustrated in FIG. 2. Here, the CSI-RS signal is transmitted through the plurality of transmitter points.

The terminal (UE) 300 uses the reference signal received from the small base station 200 to calculate the CQIₐ⁽⁰⁾ of the above Equation 3. As described above, the CQIₐ⁽⁰⁾ is the ratio of signal Sₐ⁰ transmitted to the terminal 300 and noise, that is, the Sₐ⁰/N.

Further, the terminal (UE) 300 uses the reference signal received from the small base station 200 to calculate the MTI of the above Equation 4 (S430). That is, the terminal UE (300) calculates MTI that is the ratio of interference and noise for each transmitter point (radio unit) of the small base station. When the transmitter point is two, the terminal (UE) 300 calculates MTI_{b}⁽⁰⁾ (ratio of interference from the transmitter point Tx0 and noise, I_{b}⁽⁰⁾/N) of the above Equation 4 and MTI_{b}⁽⁰⁾ (ratio of interference from the transmitter point Tx1 and noise, I_{c}⁽¹⁾/N) of the above Equation 4.

The terminal UE (300) feeds back the CQIₐ⁽⁰⁾ calculated in the step S420 and the MTI calculated in the step S430 to the small base station 200 (S440).

The small base station 200 uses the CQIₐ^{(0) and} the MTI fed back from the terminal (UE) 300 to calculate the MT-CQI as the above Equation 3 (S450). That is, the small base station 200 may know the power allocation information of each transmitter point and therefore may apply the above Equation 3 to calculate the MT-CQI.

Further, the small base station 200 uses the MT-CQI calculated in step S450 to perform the scheduling and link adaptation for the multi-user (S460). The small base station 280 may select the transmitter point transmitting an optimal data to the multi-user among the plurality of transmitter points through the MT-CQI and may also select the multi-user. By this, it is possible to reduce the interference between the transmitter point and the terminal.

FIG. 6 is a diagram illustrating a terminal according to an exemplary embodiment of the present invention.

As illustrated in FIG. 6, the terminal 300 according to the exemplary embodiment of the present invention includes a processor 310, a memory 220, and an RF module 330.

The processor 310 may be configured to embody procedures, methods, and functions described with reference to FIGS. 1 to 4.

The memory 320 is connected to the processor 310 and stores various types of information related to the operation of the processor 310.

The RF module 330 is connected to the antenna (not illustrated) and transmits and receives a radio signal. Further, the antenna may be implemented as a single antenna or a multiple antenna (MIMO) antenna.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### INDUSTRIAL APPLICABILITY

The present invention may be applied to a mobile communication system.

1. An operation method of a terminal communicating with a base station including first and second transmitter pointers positioned at different places, comprising:
receiving a reference signal for channel quality measurement from the base station;
calculating a first value that is a ratio of a signal transmitted to the terminal and noise based on the reference signal;
calculating a second value that is a ratio of interference from the first transmitter point and noise based on the reference signal;
calculating a third value that is a ratio of interference from the second transmitter point and noise based on the reference signal; and
feed backing information on the first to third values to the base station.

2. The operation method of claim 1, wherein:
the base station calculates channel quality indication for multiple transmitter MIMO based on the first to third values.

3. The operation method of claim 2, wherein:
the base station performs scheduling for the multiple transmitter MIMO based on the calculated channel quality indication.

4. The operation method of claim 2, wherein:
the multiple transmitter MIMO is a scheme of transmitting data as the same resources to the terminal and other terminals other than the terminal through the first and second transmitter points.

5. The operation method of claim 1, further comprising:
when a value obtained by dividing the second value by the first value is equal to or larger than a predetermined threshold value, allocating the second value as a fourth value; and
when a value obtained by dividing the third value by the first value is smaller than the predetermined threshold value, allocating the third value as a fifth value,
wherein information on the second value corresponds to the fourth value and information on the third value corresponds to the fifth value.

6. The operation method of claim 5, wherein:
the fourth value and the fifth value are 1 bit information.

7. The operation method of claim 1, wherein:
the base station is a small base station and the small base station is wirelessly connected to a macro base station and is connected to a back haul wirelessly and through the macro base station.

8. The operation method of claim 1, wherein:
the first transmitter point and the second transmitter point are positioned in different buildings.

9. An operation method of a base station including first and second radio units distributed from each other and a digital unit connected to the first and second radio units, comprising:
transmitting a reference signal for channel quality measurement to a terminal;
receiving a first value that is a ratio of a signal transmitted to the terminal and noise calculated based on the reference signal from the terminal;
receiving a second value that is a ratio of interference by the first radio unit and noise calculated based on the reference signal from the terminal; and
receiving a third value that is a ratio of interference by the second radio unit and noise calculated based on the reference signal from the terminal.

10. The operation method of claim 9, further comprising:
calculating channel quality indication for multiple transmitter MIMO based on the first to third values.

11. The operation method of claim 10, further comprising:
performing scheduling for the multiple transmitter MIMO based on the calculated channel quality indication.

12. The operation method of claim 10, wherein:
the multiple transmitter MIMO is a scheme of transmitting, by the base station, data as the same resources to the terminal and other terminals other than the terminal through the first and second radio units.

13. The operation method of claim 9, wherein:
the base station is a small base station and the small base station is wirelessly connected to a macro base station and is connected to a back haul wirelessly and through the macro base station.

14. A terminal communicating with a base station including first and second transmitter points distributed at different places, comprising:
an RF module receiving a reference signal for channel quality measurement from the base station; and
a processor calculating a first value that is a ratio of interference by the first transmitter point and noise and a second value that is a ratio of interference by the second transmitter point and noise based on the reference signal.

15. The terminal of claim 14, wherein:
the processor calculates a third value that is a ratio of a signal transmitted to the terminal and noise based on the reference signal.

16. The terminal of claim 15, wherein:
the RF module feeds back information on the first to third values to the base station.

17. The terminal of claim 14, wherein:
the processor
allocates the first value as a fourth value when a value obtained by dividing the first value by the third value is equal to or larger than a predetermined threshold value; and
allocates the second value as a fifth value when a value obtained by dividing the second value by the third value is equal to or larger than the predetermined threshold value.

18. The terminal of claim 17, wherein:
the RF module feeds back the third value, the fourth value, and the fifth value to the base station.

19. The terminal of claim 18, wherein:
the fourth value and the fifth value are 1 bit information.
